(19) United States
(12) Patent Application Publication
(10) Pub. No.: US 2026/0086966 A1
(43) Pub. Date: Mar. 26, 2026

(54) UART COMMUNICATIONS DEVICE WITH POWER MANAGEMENT CIRCUIT

(71) Applicant: Texas Instruments Incorporated, Dallas, TX (US)

(72) Inventors: Zhuojun Wei, HUZHOU (CN); Yicheng Zhou, WUXI JIANGSU (CN); Xiaodong Li, Shanghai (CN); Kangcheng Xu, Shanghai (CN)

(21) Appl. No.: 18/895,794

(22) Filed: Sep. 25, 2024

(51) Int. Cl. G06F 13/38; G06F 13/40

(52) U.S. Cl. CPC G06F 13/385; G06F 13/4068

(57) ABSTRACT

In described examples, a device includes a first universal asynchronous receiver-transmitter (UART) connector, a switch or diode coupled to the first UART connector, a capacitor coupled to the switch or diode, and a power management circuit coupled to the switch or diode and to the capacitor. In some examples, the first communications protocol connector is a UART receiver connector, an inter-integrated circuit (I2C) clock connector, or a serial protocol interface (SPI) clock connector.

### TECHNICAL FIELD

This application relates generally to communications systems, and in particular to powering an integrated circuit (IC) that includes a communications block.

### BACKGROUND

The universal asynchronous receiver-transmitter (UART) communications protocol enables asynchronous serial communication with configurable data format and transmission speed. UART is often used to enable device-to-device communication. UART systems can be relatively simple, low cost, and easy to implement.

### SUMMARY

In described examples, a device includes a first universal asynchronous receiver-transmitter (UART) connector, a switch or diode coupled to the first UART connector, a capacitor coupled to the switch or diode, and a power management circuit coupled to the switch or diode and to the capacitor.

### BRIEF DESCRIPTION OF THE DRAWINGS

FIG. 1 is a functional block diagram of a first IC fabricated on a semiconductor die that includes a UART block.

FIG. 2 is a functional block diagram of a first IC package that includes the IC of FIG. 1.

FIG. 3 is a functional block and circuit diagram of a second IC fabricated on a semiconductor die that includes a UART block.

FIG. 4 is a functional block and circuit diagram of a second IC package that includes the IC of FIG. 3.

FIG. 5A is a set of timing diagrams of example UART signals.

FIG. 5B is a functional block diagram of an example UART communication system that includes a first semiconductor device and a second semiconductor device configured to communicate with each other via a UART data channel.

FIG. 5C is a functional block and circuit diagram of a second example UART communication system.

FIG. 6A is a functional block and circuit diagram showing first example current flow through the IC package of FIG. 4.

FIG. 6B is a functional block and circuit diagram showing second example current flow through the IC package of FIG. 4.

FIG. 7 is a process for controlling the IC package of FIG. 4.

FIG. 8 is a functional block and circuit diagram of a third IC fabricated on a semiconductor die that includes a UART block.

FIG. 9 is a functional block and circuit diagram of an example inter-integrated circuit system, with a controller and multiple targets.

FIG. 10 is a functional block and circuit diagram of an example serial peripheral interface system.

### DETAILED DESCRIPTION

In some examples, a first UART-inclusive IC package is selectively powered from voltage provided from a second UART-inclusive IC package. Particularly, UART transmit (TX) communications include an idle (no data) state, which may be followed by binary data communications that commence with a start bit. During the idle state, the UART TX line is powered above a zero voltage state. During binary data communications, in some examples, the UART TX data line transmits a binary bit (such as a logic one) or a stop signal corresponding to a high voltage, pulled up to 3.0 volts, 3.3 volts, or 5 volts. In some examples, the UART TX data line is pulled up to the high voltage during the idle state. In some examples, the UART TX data line transmits a binary bit (such as a logic zero) corresponding to a low voltage, pulled down to zero volts. In some examples, these TX power levels provided by a UART TX data line during idle or high voltage transmission are used to sufficiently power an IC that includes a UART control circuit.

In some examples, the power provided by the idle state and high voltage data state of a UART transmission line enables a UART receive data pin to be used both for receiving data and for powering an IC that includes a UART transceiver. While the UART transmission line carries a low voltage data, the IC is powered by a capacitor that is charged by the idle state or the high voltage data. A switch closes (conducts/activates) during the idle and high voltage data states to connect the UART data line to a power management circuit of the IC and to the capacitor. The switch opens (deactivates) during the low voltage data state to enable the capacitor to discharge to power the IC and to prevent capacitor discharge from interfering with UART signal sampling.

In some examples, a number of pins in an IC package that includes an IC with a UART transceiver matches a package size that is part of a manufacturer's preexisting product line if a UART receive data line is also used to provide power to the IC. In some examples, a number of pins in the IC package does not match a package size that is part of the manufacturer's preexisting product line if a separate power supply pin is used to provide power to the IC.

Accordingly, using a UART receive data pin to power a corresponding IC can provide some or all of benefits including reducing a number of pins required by an IC package that includes the IC, reducing a size of the IC and/or the IC package, enabling an IC package to fit within strict size and/or pin requirements of an application, reducing a total power consumption of the IC, reducing a cost of the IC package, avoiding use of no-connection pins (NC pins) in the IC package, enabling use of a smaller and/or fewer-pin package size that is part of a manufacturer's preexisting product line, simplifying a routing design of a system that incorporates the IC package, or reducing a footprint of the IC package on a printed circuit board (PCB) that includes the IC package. A reduction in pin count and package size can also result in lower costs for the manufacturer and customers and allow for lighter and lower form-factor devices for the end users.

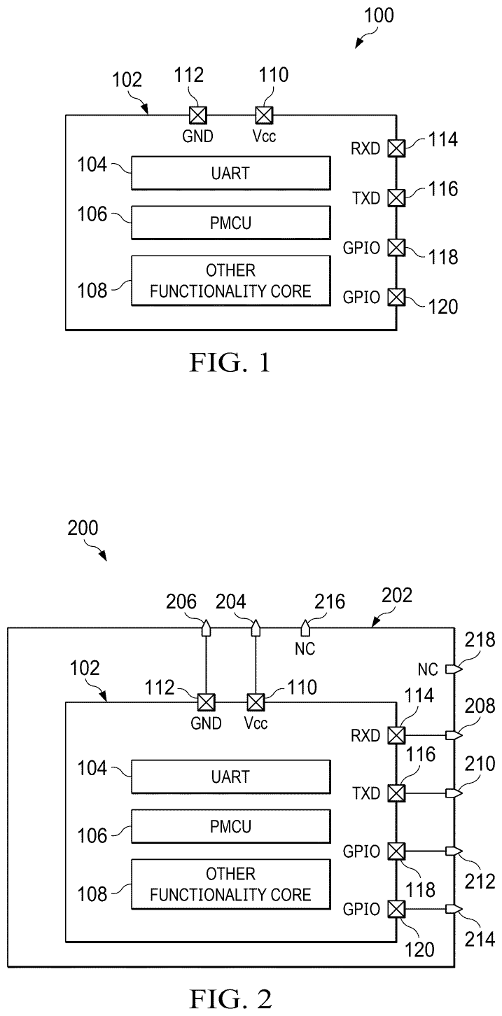

FIG. 1 is a functional block diagram of a first IC 100 fabricated on a semiconductor die 102 that includes a UART block 104. The semiconductor die 102 includes a power management control unit (PMCU) 106, an other functionality core 108, a voltage source (Vcc) contact pad 110 (and/or pin, wire, lead, solder ball, or other external connector on a surface of the IC 100), a ground (GND) contact pad 112, a receive data (RXD) contact pad 114, a transmit data (TXD) contact pad 116, a fifth contact pad 118, and a sixth contact pad 120. In some examples, the other functionality core 108 is or relates to a general purpose input/output (GPIO) control circuit, an analog to digital converter (ADC), a boot controller, or a switch duty (SWD) controller. In some examples, the other functionality core 108 is or includes, or some or all of the components fabricated on the semiconductor die 102 are included in, a processor such as a microcontroller unit (MCU), a digital signal processor (DSP), or a central processing unit (CPU). Additional example details of UART structure and communication can be found in commonly assigned U.S. Pat. No. 11,204,887, entitled “Methods and Systems for Using UART and Single Wire Protocols,” filed Nov. 24, 2020, which is incorporated by reference in its entirety.

In some examples, the PMCU 106 is connected to the Vcc contact pad 110 and the GND contact pad 112, and distributes power throughout the IC 100, such as to the UART block 104 and the other functionality core 108. In some examples, the UART block 104 is connected to the RXD contact pad 114 to enable receiving data, and is connected to the TXD contact pad 116 to enable transmitting data. In some examples, the other functionality core 108 is connected to the fifth and sixth contact pads 118 and 120 to enable functionality that uses or relates to communication with other devices. In the illustrated examples of FIGS. 1 and 2, the fifth and sixth contact pads 118 and 120 are used for GPIO communications. In some examples, the fifth and/or sixth contact pads 118 and 120 are used for receiving ADC input or control signals and/or transmitting ADC output, receiving a reset signal such as a low reset (NRST) signal, or receiving SWD configuration or control data or transmitting switch control signals.

FIG. 2 is a functional block diagram of a first IC package 200 that includes the IC 100 of FIG. 1. The IC package 200 includes a package body 202, a Vcc pin 204 (and/or contact pad, wire, lead, solder ball, or other external connector on a surface of the IC package 200), a GND pin 206, an RXD pin 208, a TXD pin 210, a first GPIO pin 212, a second GPIO pin 214, a first NC pin 216, and a second NC pin 218. In some examples, the package body 202 includes various metal layers and dielectric that protect, physically and electrically connect, provide physical structure and organization to, and/or encapsulate the other components of the IC package 200, such as the semiconductor die 102.

The Vcc contact pad 110 is connected to the Vcc pin 204, the GND contact pad 112 is connected to the GND pin 206, the RXD contact pad 114 is connected to the RXD pin 208, the TXD contact pad 116 is connected to the TXD pin 210, the first GPIO contact pad 118 is connected to the first GPIO pin 212, and the second GPIO contact pad 120 is connected to the second GPIO pin 214.

In some examples, the IC package 200 is a small outline integrated circuit (SOIC) or small outline package (SOP) or other standard size package, such as an SOP-8. In some examples, a manufacturer may have a preexisting product line of IC packages with a certain number of pins. Further, sometimes such a package may have more pins than the IC 100 that is incorporated into the package. For example, as illustrated in FIG. 2, the IC package 200 has eight pins 204, 206, 208, 210, 212, 214, 216, and 218 and the IC 100 has six contact pads 110, 112, 114, 116, 118, and 120. Accordingly, the IC package 200 has two extra pins that are not connected to contact pads (e.g., not used), and so are designated NC pins 216 and 218.

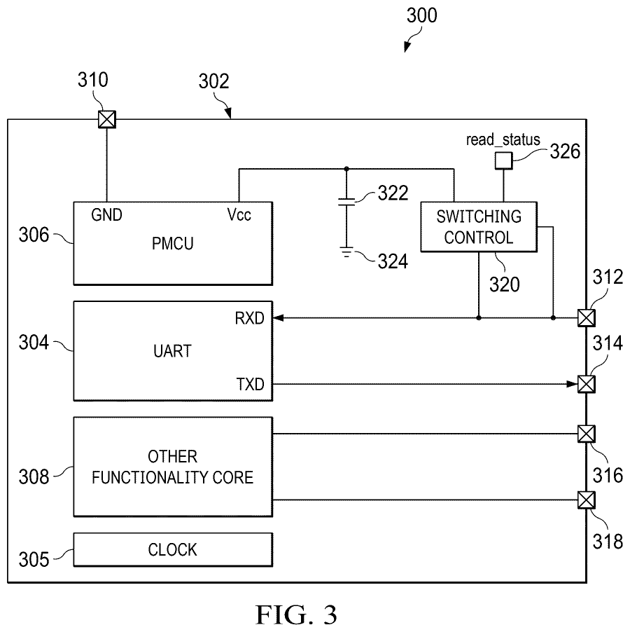

FIG. 3 is a functional block and circuit diagram of a second IC 300 fabricated on a semiconductor die 302 that includes a UART block 304. The semiconductor die 302 includes a clock circuit 305 that provides a clock signal, a PMCU 306, an other functionality core 308, a GND contact pad 310, an RXD contact pad 312, a TXD contact pad 314, a first GPIO contact pad 316, a second GPIO contact pad 318, a switching control circuit 320, a capacitor 322, and a ground terminal 324 adapted to provide a ground voltage.

A GND terminal of the PMCU 306 is connected to the GND contact pad 310. A Vcc terminal of the PMCU 306 is connected to a first terminal of the capacitor 322 and a first terminal of the switching control circuit 320. A second terminal of the capacitor 322 is connected to the ground terminal 324. A second terminal and a control terminal of the switching control circuit 320 are connected to the RXD contact pad 312 and an RXD terminal of the UART block 304. A status terminal of the switching control circuit 320 is connected to a read status terminal 326. The TXD contact pad 314 is connected to a TXD terminal of the UART block 304. The first GPIO contact pad 316 is connected to a first terminal of the other functionality core 308, and the second GPIO contact pad 318 is connected to a second terminal of the other functionality core 308.

In some examples, the switching control circuit 320 includes a transistor including two load terminals and a control terminal. A first load terminal is coupled to the Vcc terminal of the PMCU 306 and coupled to the capacitor 322, a second load terminal is coupled to the RXD contact pad 312, and the control terminal is coupled to the RXD contact pad 312. Thus, the transistor can be implemented as a diode-connected transistor having one load terminal coupled to the control terminal, which are both coupled to the RXD contact pad 312.

The clock circuit 305 provides the clock signal to the UART block 304. In some examples, the clock signal has a higher frequency than a UART data signal to enable reliable sampling of the UART data signal. In some examples, the read status terminal 326 can be used to determine whether the switching control circuit 320 is closed (conductive) or open. In some examples, a voltage at the read status terminal 326, corresponding to a logic value indicating status of the switching control circuit 320, is responsive to a voltage received from the RXD contact pad 312 by the switching control circuit 320. In some examples, the read status terminal 326 provides switching status information to a register (not shown) included in the UART block 304. In some examples, this register enables reading the state of the switching control circuit 320 using software, such as software executed by a processor of the other functionality core 308 or by an external processor.

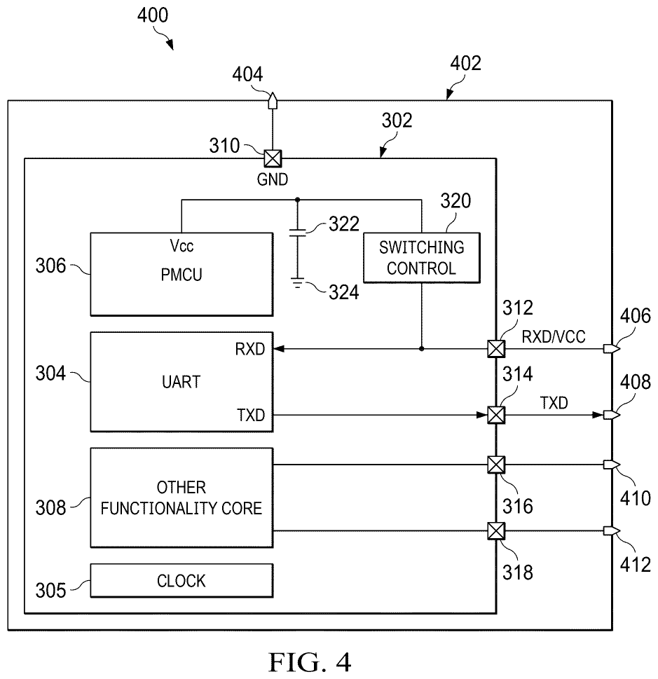

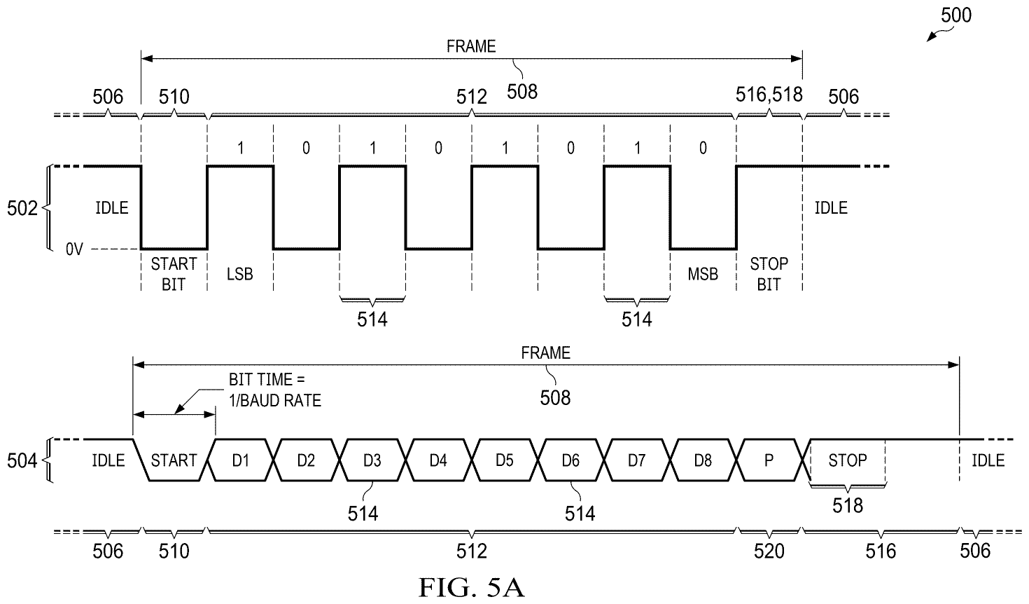

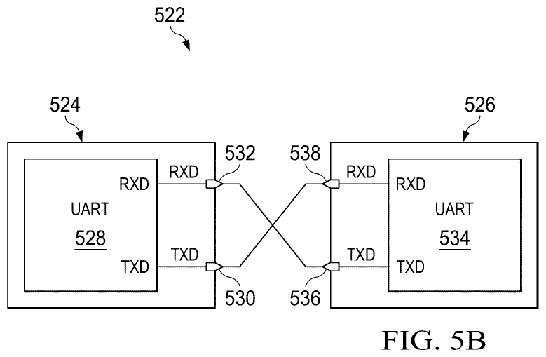

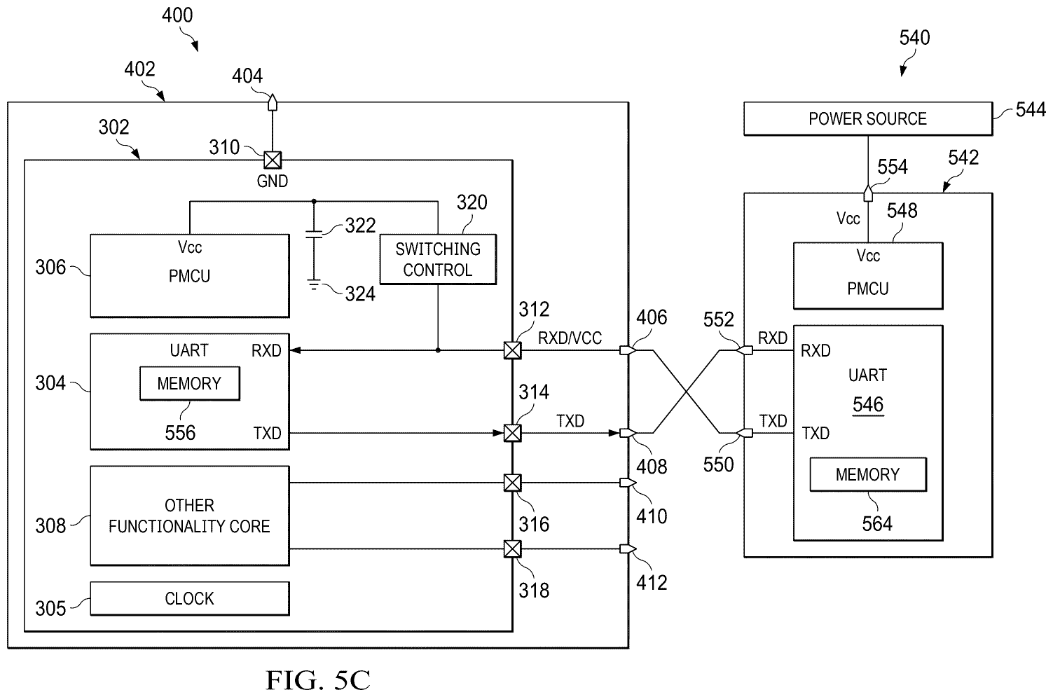

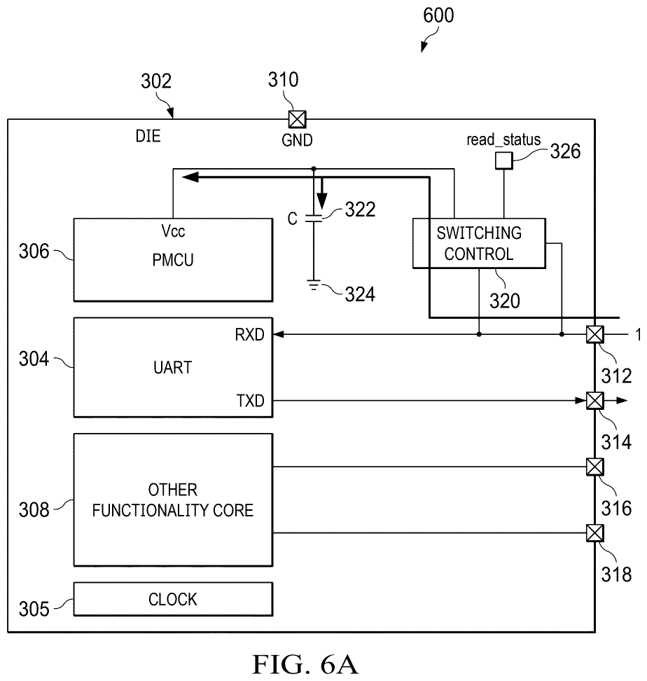

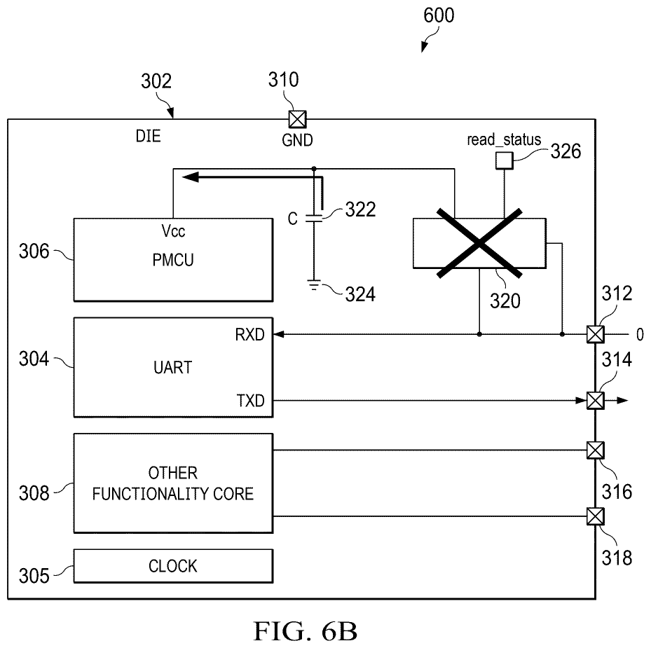

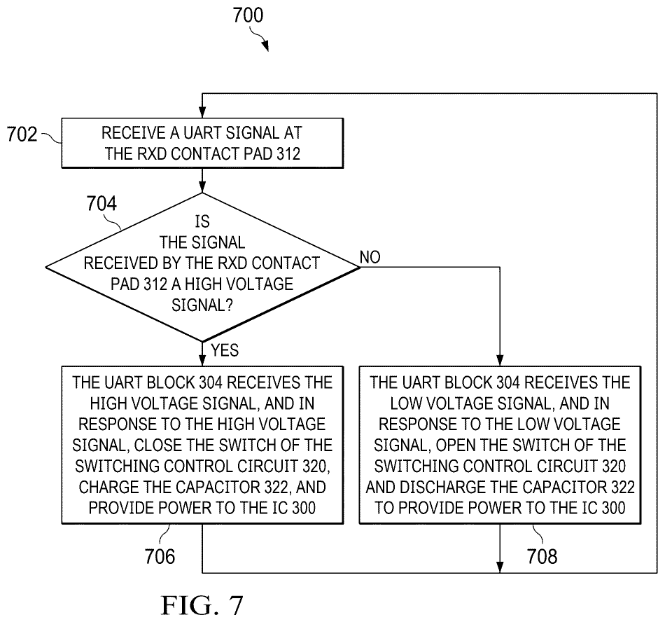

An IC package 400 that includes the IC 300 is described with respect to FIG. 4. The UART communication protocol is described with respect to FIG. 5. Use of the idle and high voltage states of the UART communication protocol to power the IC 300 is described with respect to FIGS. 6A and 6B. A process for powering the IC 300 using a UART communication line is described with respect to FIG. 7.

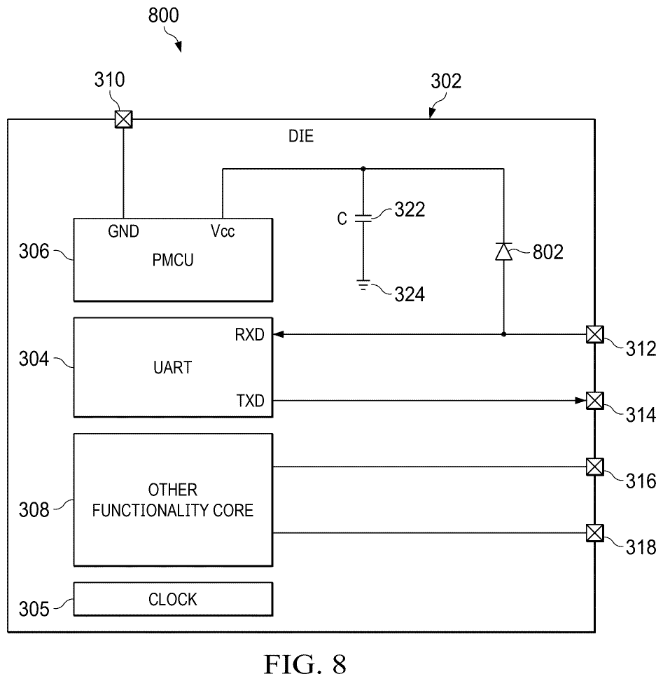

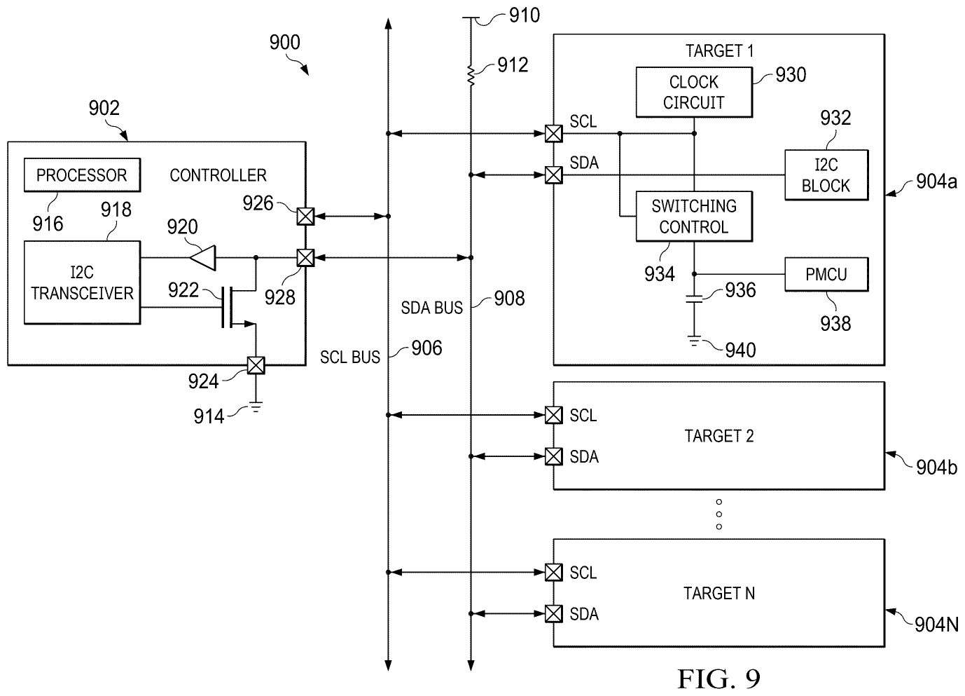

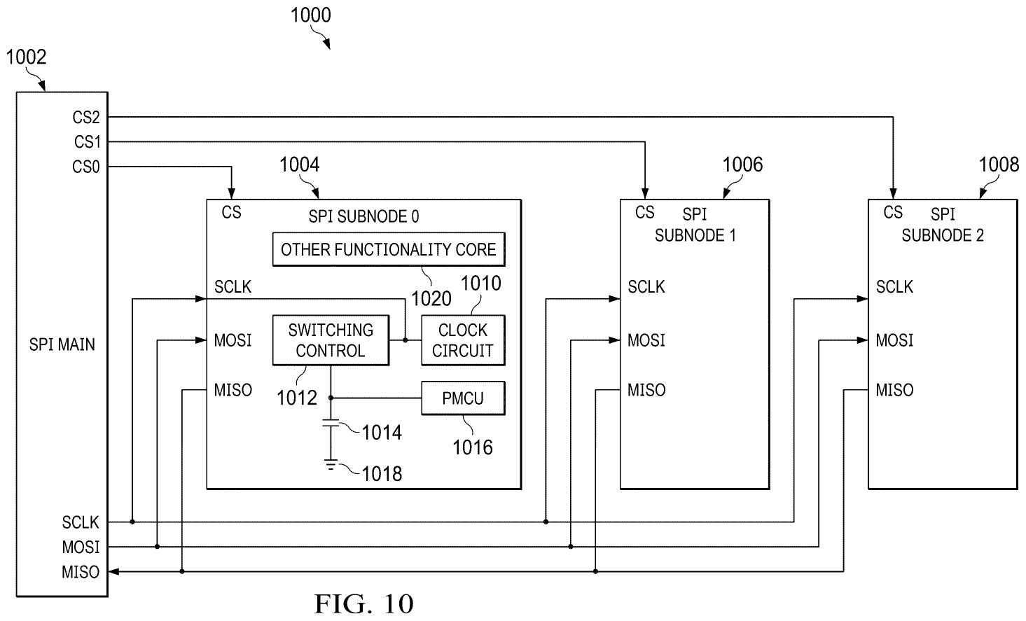

Further alternative implementations are described herein. In some examples, a diode can be used instead of a switching circuit, as further described with respect to FIG. 8. In some examples, structures and processes described herein can be applied to a system implementing a communications protocol other than UART, such as an inter-integrated circuit (I2C) communications system or a serial peripheral interface (SPI) communications system. In some examples, a clock connector (CLK connector) of a target device in an I2C communications system can be used to receive power from a clock line (SCL line), as further described with respect to FIG. 9. In some examples, a serial clock (SCLK) connector of an SPI subnode device in an SPI communications system can be used to receive power from an SPI main device, as further described with respect to FIG. 10.

FIG. 4 is a functional block and circuit diagram of a second IC package 400 that includes the IC 300 of FIG. 3. The IC package 400 includes a package body 402, a GND pin 404, an RXD/Vcc pin 406, a TXD pin 408, a first GPIO pin 410, and a second GPIO pin 412. The RXD/Vcc pin 406 is used to receive UART data signals (corresponding to RXD) that, along with the UART idle state, provide power (corresponding to Vcc) to the IC 300.

The GND pin 404 is connected to the GND contact pad 310, the RXD/Vcc pin 406 is connected to the RXD contact pad 312, the TXD pin 408 is connected to the TXD contact pad 314, the first GPIO pin 410 is connected to the first GPIO contact pad 316, and the second GPIO pin 412 is connected to the second GPIO contact pad 318. In some examples, the IC package 400 is a five pin SOIC package, a five pin SOP (SOP-5) SOP-5 package, or another standard sized 5-pin package. Functionality of the IC package 400 is described with respect to FIGS. 5C, 6A, and 6B.

FIG. 5A is a set of timing diagrams 500 of example UART signals. The timing diagrams 500 include a first timing diagram 502 and a second timing diagram 504. The first timing diagram 502 includes a high voltage idle state 506 that surrounds a frame 508 that includes a low voltage start bit 510, a data period 512 that includes one or more data bits 514, and a stop signal 516 that includes one or more stop bits 518. The second timing diagram 504 includes the elements described with respect to the first timing diagram 502, and also includes a parity bit 520. In some examples, data bits 514 are transmitted during a data period 512 from a least significant bit (LSB) to a most significant bit (MSB).

A device implementing the techniques of this disclosure can activate a switch or diode and charge a capacitor during the stop bit(s) 518, the idle state 506, or the logic high states labeled as 514 in FIG. 5A. The duration of each stop bit(s) 518, idle state 506, and/or logic high state on the transmission line may be sufficiently long to charge the capacitor in the receiving device. While a logic low state is present on the transmission line, the switch may be deactivated, and the capacitor in the receiving device may discharge to provide energy to the PMCU.

The frames 508 illustrated in the example timing diagrams 502 and 504 each include eight data bits 514. UART frames 508 can include more or fewer than eight data bits 514. A duration of a single bit, such as a data bit 514, a start bit 510, a parity bit 520, or a stop bit 518, equals one divided by a baud rate (data rate) of the UART signal. A data rate of the UART signal is a frequency of transmission of bits of the UART signal.

FIG. 5B is a functional block diagram of a first example UART communication system 522 that includes a first semiconductor device package 524 and a second semiconductor device package 526 configured to communicate with each other via a UART data channel. The first semiconductor device package 524 includes a first UART block 528, a first TXD pin 530, and a first RXD pin 532. The second semiconductor device package 526 includes a second UART block 534, a second TXD pin 536, and a second RXD pin 538. The first and second semiconductor device packages 524 and 526 may include additional circuits and/or pins.

The first TXD pin 530 is connected to a TXD terminal of the first UART block 528 and to the second RXD pin 538. The first RXD pin 532 is connected to an RXD terminal of the first UART block 528 and to the second TXD pin 536. The second TXD pin 536 is connected to a TXD terminal of the second UART block 534, and the second RXD pin 538 is connected to an RXD terminal of the second UART block 534. Accordingly, the TXD terminal of the first UART block 528 is connected to the RXD terminal of the second UART block 534, and the TXD terminal of the second UART block 534 is connected to the RXD terminal of the first UART block 528.

The UART data channel that communicatively connects the first semiconductor device package 524 to the second semiconductor device package 526 corresponds to the transmitter/receiver connections between the first UART block 528 and the second UART block 534. In some examples, the first semiconductor device package 524 and the second semiconductor device package 526 are configured to communicate via the UART data channel using a same data rate (bit speed), a same number of data bits 514 per frame 508, a same number of stop bits 518, and to both include or both not include a parity bit 520 in each frame 508.

FIG. 5C is a functional block and circuit diagram of a second example UART communication system 540. The UART communication system 540 includes the IC package 400 of FIG. 4, a semiconductor device package 542, and a power source 544. The semiconductor device package 542 includes a UART block 546, a PMCU 548, a TXD pin 550, an RXD pin 552, and a Vcc pin 554. The UART block 546 includes a first memory 564 for storing UART configuration settings such as a data rate, a number of data bits 514 per frame 508, a number of stop bits 518, and whether to include a parity bit 520 in each frame 508. In the IC package 400, the UART block 304 includes a second memory 556 for storing UART configuration settings.

The TXD pin 408 is connected to the RXD pin 552, the TXD pin 550 is connected to the RXD/Vcc pin 406, the RXD pin 552 is connected to the RXD terminal of the UART block 546, and the TXD pin 550 is connected to the TXD terminal of the UART block 546. The power source 544 is connected to the Vcc pin 554, and the Vcc pin 554 is connected to the Vcc terminal of the PMCU 548.

The PMCU 548 distributes power to other circuits of the semiconductor device package 542, including the UART block 546. Accordingly, the UART block 546 is enabled to provide power to the IC package 400. Power is provided from the power source 544, to the PMCU 548 via the Vcc pin 554, to the UART block 546. The UART block 546 provides power (transmitted as electrical current) to the PMCU 306 and the capacitor 322 via the TXD pin 550, the RXD/Vcc pin 406, the RXD contact pad 312, and the switching control circuit 320.

An IC package 400 is configured to transmit and receive a number D data bits 514 and a number P (zero or one) parity bits 520 per frame 508, with a data rate of R. Accordingly, if there is no idle time between frames 508, there will be a maximum lapsed time T_{L} between high voltage signal levels corresponding to a time between stop signals 516, so that T_{L}≤(D+P+1)/R. T_{L} equals the length of a frame 508 minus a duration of the stop signal 516. In an example, a UART data channel is configured to use eight data bits 514, a parity bit, and a data rate equal to 9600 baud (9600 data bits 514 per second), so that T_{L} equals 1/960 seconds (0.00104 seconds).

While the RXD/Vcc pin 406 receives a high voltage signal from the TXD pin 550 of the semiconductor package 542, a switch corresponding to the switch control circuit 320 is closed, so that the capacitor 322 charges and the high voltage signal powers the IC 300. While the RXD/Vcc pin 406 receives a low voltage signal, the switch corresponding to the switch control circuit 320 is open, so that the capacitor 322 discharges to power the IC 300. Fully charging the capacitor 322 enables the IC 300 to continue functioning properly for a duration T_{D} (discharge duration) while the RXD/Vcc pin 406 receives the low voltage signal. The duration T_{D} is described by Equation 1. T_{D} is dependent on a work voltage (V_{WORK}) of the UART data channel to which the capacitor 322 is charged, a cutoff voltage (V_{CUTOFF}) of the IC 300 below which the IC 300 stops working properly, a work current (I_{WORK}) provided by the capacitor 322 to the PMCU 306 while the capacitor 322 discharges, and C is the capacitance of the capacitor 322. Accordingly, T_{D} is the time taken for the capacitor 322 to discharge from V_{WORK} to V_{CUTOFF}, as shown in Equation 1:

$${T}_{D} = \frac{C}{{I}_{WORK}} \times \frac{{V}_{WORK}^{2} - {V}_{CUTOFF}^{2}}{{V}_{WORK} + {V}_{CUTOFF}} \qquad Equation 1$$

If T_{D}≥T_{L}, then while the UART data channel carries a high voltage signal, the capacitor 322 can power the IC 300 regardless of data content (such as all zeroes) of the UART signal received by the IC package 400 at the RXD/Vcc pin 406. In an example, V_{WORK} equals 3.3 volts, V_{CUTOFF} equals 1.6 volts, and I_{WORK} equals 1 microAmpere, and T_{L} is 0.001 seconds, so that C is 0.6 nanofarads (nF) or more. Accordingly, a 1.0 nF capacitor can be used for the capacitor 322 in this example. In some examples, a maximum data rate (baud rate) is responsive to discharge time T_{D} of the capacitor 322 and UART configuration settings, such as a configured number of data bits, parity bits, etc., per message frame.

In some examples, the resistance in the charging loop for the capacitor 322 is very low, such as a line resistance, and the charging time for the capacitor is correspondingly short, such as less than one microsecond. In some examples, the charging time for the capacitor 322 is responsive to line resistance and parasitic capacitance of the capacitor 322.

In some examples, an IC 300 has a higher or lower power demand than in the above-described example. In some examples, a 10 nF to 100 nF capacitor is used for the capacitor 322. In some examples, a different capacitance is used for the capacitor 322. In some examples, multiple transistors connected in parallel are used to implement the capacitor 322.

FIG. 6A is a functional block and circuit diagram of a second example UART system 600 showing a first current flow through the IC 300 of FIG. 4. Current flow is indicated by arrowed lines. The IC 300 receives an idle signal 506, a logic one data signal 514, or a stop signal 518 at the RXD contact pad 312. These signals correspond to a high voltage signal, and are collectively indicated in FIG. 6A by a “1” at the RXD contact pad 312. The “1” signal is received by the control terminal of the switching control circuit 320, which includes a corresponding switch that closes in response to the “1”. Accordingly, current from the RXD contact pad 312 flows through the switching control circuit 320 to the capacitor 322 and to the Vcc terminal of the PMCU 306. This current flow charges the capacitor 322, and the PMCU 306 distributes electrical power corresponding to the current flow from the RXD contact pad 312 to power the IC 300.

FIG. 6B is a functional block and circuit diagram of the second example UART system 600 showing a second example current flow through the IC 300 of FIG. 4. Current flow is indicated by arrowed lines. The IC 300 receives a start bit 510 or a logic zero data signal 514 at the RXD contact pad 312. These signals correspond to a low voltage signal, and are collectively indicated in FIG. 6B by a “0” at the RXD contact pad 312. The “0” signal is received by the control terminal of the switching control circuit 320 and causes the corresponding switch to open. Accordingly, the capacitor 322 discharges, so that current flows from the capacitor 322 to the Vcc terminal of the PMCU 306. The PMCU 306 distributes electrical power corresponding to the current flow from the capacitor 322 to power the IC 300. Accordingly, in contrasting FIG. 6A in 6B, the TX line of a second UART device may be coupled to the RXD contact pad 312. In FIG. 6A, a high voltage is provided from the RXD contact pad 312 as both the VCC and capacitor 322 charging power. In FIG. 6B, a low voltage is provided from the RXD contact pad 312, in which case the previously-charged capacitor 322 provides the VCC power.

FIG. 7 is a process 700 for controlling the IC 300 of FIG. 3. In step 702, the RXD contact pad 312 receives a UART signal. In step 704, the switching control circuit 320 determines whether a signal received by the RXD contact pad 312 is a high voltage signal, such as a UART idle signal 506, a UART logic one data signal 514, or a UART stop signal 518. If the received signal is a high voltage signal, then the process 700 proceeds to step 706. Otherwise, the process 700 proceeds to step 708.

In step 706, the UART block 304 receives the high voltage signal, and in response to the high voltage signal, the switch of the switching control circuit 320 closes so that the high voltage signal charges the capacitor 322 and provides power to the IC 300. In step 708, the UART block 304 receives the low voltage signal, and in response to the low voltage signal, the switch of the switching control circuit 320 opens so that the capacitor 322 discharges while providing power to the IC 300. After step 706 or step 708, the process 700 returns to step 702.

FIG. 8 is a functional block and circuit diagram of a third IC 800 fabricated on a semiconductor die 302 that includes a UART block 304. The IC 800 includes a diode 802 instead of the switching control circuit 320. An anode of the diode 802 is connected to the RXD contact pad 312 and the RXD terminal of the UART block 304, and a cathode of the diode 802 is connected to the first terminal of the capacitor 322 and the Vcc terminal of the PMCU 306.

The diode 802 passes current provided at the RXD contact pad 312 while a signal received by the RXD contact pad 312 has a high voltage. The current passed by the diode 802 charges the capacitor 322 and provides electrical power to the PMCU 306, which distributes the power to other circuits of the IC 800. While the signal received at the RXD contact pad 312 has a low voltage, the capacitor 322 discharges. The diode 802 prevents current from the capacitor 322 from flowing toward the RXD contact pad 312 and the UART block 304. Current from the capacitor 322 instead flows to the Vcc terminal of the PMCU 306, and the PMCU 306 distributes corresponding power to other circuits of the IC 800.

FIG. 9 is a functional block and circuit diagram of an example I2C system 900, with a controller 902 and multiple targets 904. In some examples, an I2C system includes multiple controllers. FIG. 9 also shows example circuitry for determining logic values of bits in serial data (SDA) signals. The controller 902 and each of the targets 904 are respectively connected to an SCL bus 906 at a corresponding clock (SCLK) pin and to the SDA bus 908 at a corresponding data (SDA) pin. The SCL bus 906 is carries a clock signal to clock the targets 904, and the SDA bus 906 carries data signals from the controller 902 to a specified target 904, or from a target 904 to the controller 902. The SDA bus 908 includes a voltage source 910 providing a source voltage, and a resistor 912. The I2C system 900 also includes a ground terminal 914 adapted to provide a ground voltage.

The controller 902 includes a processor 916, an I2C transceiver 918, a buffer 920, an n-channel metal-oxide-semiconductor field-effect transistor (an NMOS) 922, a ground pin 924, an SCL pin 926, and an SDA pin 928. The targets 904 include a first target (target 1) 904a, a second target (target 2) 904b, through an N^{th} target (target N) 904N. Each of the targets 904 is connected to the SCL bus 906 and the SDA bus 908. The first target 904a is shown and described as representative of the targets 904. The first target 904a includes a clock circuit 930, an I2C block 932, a switching control circuit 934 (or a diode, FIG. 8), a capacitor 936, a PMCU 938, and a ground terminal 940. In some examples, the structures of the target 904 are included in an IC. The structures of the target 904 are electrically connected to pins of the target 904 (such as the SCL and SDA pins) via, for example, contact pads on a surface of the IC.

The SDA pin 928 of the controller 902 is connected to an input of the buffer 920 and a drain of the NMOS 922. An output of the buffer 920 is connected to a data input of the I2C transceiver 918, and a gate of the NMOS 922 is connected to a data output of the transceiver 918. This data input and data output of the I2C transceiver 918 correspond to an SDA terminal of the I2C transceiver 918. In some examples, an SCL terminal of the I2C transceiver 918 is connected and provides a clock signal to the SCL bus 906. The source of the NMOS 922 is connected to the ground terminal 914 via the ground pin 924.

The SCL bus 906 is provided a clock signal during data transmission. In some examples, the controller 902 provides the SCL bus 906 the clock signal using a buffer, NMOS, and ground controlled by the I2C transceiver 918. In some examples, corresponding structure and connections are a copy of those used by the I2C transceiver 918 to provide the SDA signal. In some examples, the SCL bus 906 is pulled to a high voltage state during an idle state corresponding to no data transmission.

In target 1 904a, the SDA pin is connected to a data terminal of the I2C block 932. The SCL pin is connected to a control terminal of the clock circuit 930 and to a first terminal and a control terminal of the switching control 934 (or to an anode of a diode). A second terminal of the switching control 934 (or a cathode of a diode) is connected to a first terminal of the capacitor 936 and a power terminal of the PMCU 938. A second terminal of the capacitor 936 is connected to the ground terminal 940.

Accordingly, while the SCL bus 906 has a high voltage state, such as during half of a clock cycle or during an idle state, the switch is closed (or the diode passes current in a first direction) so that current flows to the capacitor 936 and the PMCU 938. This charges the capacitor 936 and enables the PMCU 938 to distribute power to other circuits of target 1 904a. While the SCL bus 906 has a low voltage state, such as during the other half of the clock cycle, the switch is open (or the diode prevents current from passing in a second direction), and the capacitor 936 discharges. The discharging capacitor 936 provides current to the PMCU 938 for power distribution to the rest of the circuits of target 1 904a.

The SDA bus 908, as a serial interface, is connected to provide two different logic states. In this regard, the SDA bus 908 is connected to the voltage source 910 via the resistor 912, so that the SDA bus 908 is pulled high (to the source voltage), providing power to target 1 904a, by default. The high voltage represents a first of the two different logic states, such as logic zero. The I2C transceiver 918 can connect the SDA bus 908 to ground 914 by providing a gate voltage to the NMOS 922 to turn on the NMOS 922. Accordingly, turning on the NMOS 922 pulls the SDA bus 908 to a low (ground) voltage. The low voltage represents a second of the two different logic states, such as logic one. The I2C transceiver 918 can monitor an SDA signal, and thus the logic value represented, on the SDA bus 908 via the SDA pin 928 and the buffer 920 by turning off the NMOS 922. This is referred to as the first controller 902 releasing the SDA bus 908.

The controller 902 can send an SDA signal representing a read or write command to the SDA bus 908. In some examples, SDA signals transmitted by the controller 902 are high at various points, such as at START condition signals, which charges the capacitor 936. START condition signals correspond to a falling edge of an SDA signal while the SCL signal is high. In some examples, multiple START signals are included within an STA signal transmitted by the controller 902.

FIG. 10 is a functional block diagram of an example SPI system 1000. The SPI system 1000 includes an SPI main 1002, a first SPI subnode (SPI subnode 0) 1004, a second SPI subnode (SPI subnode 1) 1006, and a third SPI subnode (SPI subnode 2) 1008. A first chip select (CS) output (CS0) of the SPI main 1002 is connected to a CS input of SPI subnode 0 1004. A second CS output (CS1) of the SPI main 1002 is connected to a CS input of SPI subnode 1 1006. A third CS output (CS2) of the SPI main 1002 is connected to a CS input of SPI subnode 2 1008. SPI subnode 0 1004 includes a clock circuit 1010, a switching circuit 1012 (or diode, FIG. 8), a capacitor 1014, a PMCU 1016, an other functionality core 1020, and a ground terminal 1018 adapted to provide a ground voltage. Subnode 0 1004 is shown and described as representative of the subnodes 1004, 1006, and 1008.

A serial clock (SCLK) output of the SPI main 1002 is connected to the respective SCLK inputs of SPI subnodes 0, 1, and 2 (1004, 1006, and 1008). A main out subnode in (MOSI) output of the SPI main 1002 is connected to the respective MOSI inputs of SPI subnodes 0, 1, and 2 (1004, 1006, and 1008) by a bus. A main in subnode out (MISO) input of the SPI main 1002 is connected to the respective MISO outputs of SPI subnodes 0, 1, and 2 (1004, 1006, and 1008) by a bus. In some examples, data can be transmitted between MOSI ports simultaneously with data being transmitted between MISO ports, corresponding to a full duplex interface. In some examples, one or more of the SPI main 1002 or the SPI subnodes 1004, 1006, or 1008 are respectively included in a corresponding IC encapsulated in a corresponding package. In some examples, described inputs and outputs correspond to pins, contact pads, and/or pins connected to contact pads.

The SCLK input of SPI subnode 0 1004 is connected to an input of the clock circuit 1010, a first terminal and a control terminal of the switching circuit 1012 (or an anode of the diode). A second terminal of the switching circuit 1012 (or a cathode of the diode) is connected to a first terminal of the capacitor 1014 and a power terminal of the PMCU 1016. A second terminal of the capacitor 1014 is connected to the ground terminal 1018.

The SPI main 1002 provides the SCLK line a clock signal during data transmission. Accordingly, while the SCLK signal has a high voltage the switching circuit 1012 is closed (or the diode conducts current), the capacitor 1014 charges, and the SCLK signal provides power to the PMCU 1016 for distribution to other circuits of SPI subnode 0 1004. While the SCLK signal has a low voltage the switching circuit 1012 is open (or the diode does not conduct current), and the capacitor 1014 discharges, so that current flows from the capacitor 1014 to the PMCU 1016 to provide power for distribution to other circuits of SPI subnode 0 1004. In some examples, the SCLK line is pulled up to high during an idle state corresponding to no data being transmitted over the MOSI line, so that the SPI subnode 0 1004 can remain powered.

To begin SPI communication, the SPI main 1002 sends the SCLK signal and selects an SPI subnode 1004, 1006, or 1008 by enabling a corresponding CS signal, such as a CS signal provided by the CS0 output, the CS1 output, or the CS2 output. In some examples, the SPI main 1002 continuously provides the SCLK signal. In some examples, the CS signal is active low, while in other examples, the CS signal is active high. Selecting an SPI subnode 1004, 1006, or 1008 by enabling a corresponding CS signal determines which SPI subnode 1004, 1006, or 1008 is activated to provide a signal responsive to the SCLK signal. In some examples, an SPI system 1000 does not use CS signals, and/or does not include CS inputs and outputs. In some examples, the MOSI data signal represents instructions to be executed by, control signals for, or configuration parameters for the selected SPI subnode 1004, 1006, or 1008. In some examples, a MISO signal provides data stored by a corresponding subnode, such as stored sensor data captured by a sensor corresponding to the subnode.

Modifications are possible in the described examples, and other examples are possible, within the scope of the claims.

In some examples, ICs and packages described herein may include different, fewer, or additional circuits and/or contact pads and/or pins.

In some examples, processes described herein are implemented using hardware, software, or a combination of hardware and software.

In some examples, ICs described herein may include a processor such as a central processing unit (CPU), a digital signal processor (DSP), or a microcontroller unit (MCU).

In some examples, a pin or other component dedicated to a function refers to that pin or other component being used solely for that function.

In some examples, a signal on the SDA bus 908 is used to power an I2C target. In some examples, a data signal is used to power a device, such as an SPI subnode. In some examples, a clock signal or data signal is used to power a device that includes a communications control circuit for a communications protocol other than UART, I2C, or SPI.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or IC package) and may be adapted to be coupled to at least some of the passive elements and/or the sources to form the described structure either at a time of manufacture or after a time of manufacture, for example, by an end-user and/or a third-party.

The techniques described in this disclosure may also be embodied or encoded in an article of manufacture including a non-transitory computer-readable storage medium, such as memory 140. Example non-transitory computer-readable storage media may include random access memory (RAM), read-only memory (ROM), programmable ROM, erasable programmable ROM, electronically erasable programmable ROM, flash memory, a solid-state drive, a hard disk, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can, over time, change (e.g., in RAM or cache).

While the use of particular transistors are described herein, other transistors (or equivalent devices) may be used instead with little or no change to the remaining circuitry. For example, a metal-oxide-silicon FET (“MOSFET”) (such as an n-channel MOSFET, nMOSFET, or a p-channel MOSFET, pMOSFET), a bipolar junction transistor (BJT—e.g. NPN or PNP), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a silicon germanium (SiGe) substrate, a gallium nitride substrate (GaN) or a gallium arsenide substrate (GaAs).

Circuits described herein may be reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples may be included in an IC and other elements are external to the IC, in other example embodiments, additional or fewer features may be incorporated into the IC. In addition, some or all of the features illustrated as being external to the IC may be included in the IC and/or some features illustrated as being internal to the IC may be incorporated outside of the IC. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. A device comprising:
a first communications protocol connector;
a switch or a diode, the switch or diode coupled to the first communications protocol connector;
a capacitor coupled to the switch or diode; and
a power management circuit coupled to the switch or diode and to the capacitor.

2. The device of claim 1, wherein the first communications protocol connector is a UART receiver connector, an inter-integrated circuit (I2C) clock connector, or a serial protocol interface (SPI) clock connector.

3. The device of claim 1, further comprising a control circuit coupled to the first communications protocol connector.

4. The device of claim 3,
wherein the diode includes an anode and a cathode,
wherein the first communications protocol connector is coupled to the anode of the diode,
wherein the capacitor is coupled to the cathode of the diode, and
wherein the first communications protocol connector is on a surface of the device.

5. The device of claim 4, further comprising a UART receive pin and a UART transmit pin,
wherein the first UART connector is coupled to the UART receive pin, and
wherein the second UART connector is coupled to the UART transmit pin.

6. The device of claim 1, wherein the switch is arranged as a diode-connected transistor including:
a first current terminal coupled to the capacitor and to the power management circuit;
a second current terminal coupled to the first UART connector; and
a control terminal coupled to the first UART connector.

7. The device of claim 1, further comprising a ground terminal, wherein the capacitor includes:
a first terminal coupled to the power management circuit and to the switch or diode; and
a second terminal coupled to the ground terminal.

8. The device of claim 1, further comprising a ground pin, wherein the device does not include a dedicated power supply pin.

9. The device of claim 1, wherein the device includes five or fewer pins.

10. The device of claim 1, wherein the IC package is a five pin small outline integrated circuit package (5-pin SOIC) or a five pin small outline package (SOP-5).

11. The device of claim 1, wherein a time for the capacitor to discharge from a UART operating voltage to a minimum operating voltage is greater than a time between two UART stop signals.

12. The device of claim 1,
wherein the switch includes a first terminal, a second terminal, and a control terminal,
wherein the first communications protocol connector is coupled to the first terminal and the control terminal of the switch,
wherein the capacitor is coupled to the second terminal of the switch, and
wherein the first communications protocol connector is on a surface of the device.

13. A system comprising:
a first device that includes:
a first communications protocol connector;
a switch or a diode coupled to the first communications protocol connector;
a capacitor coupled to the switch or diode; and
a power management circuit coupled to the switch or diode and to the capacitor;
a second device that includes a second communications protocol connector; and
a communication line,
wherein the second communications protocol connector is coupled to the first communications protocol connector by the communication line.

14. The system of claim 13, wherein the communications protocol is a universal asynchronous receiver-transmitter (UART) protocol, an inter-integrated circuit (I2C) protocol, or a serial peripheral interface (SPI) protocol.

15. The system of claim 13,
wherein the first device is encapsulated by a first encapsulation,
wherein the second device is encapsulated by a second encapsulation that is separate from the first encapsulation, and
wherein the first communications protocol connector is on a surface of the first encapsulation, and
wherein the second communications protocol connector is on a surface of the second encapsulation.

16. The system of claim 13,
wherein the switch includes a first terminal, a second terminal, and a control terminal,
wherein the first communications protocol connector coupled to the first terminal and the control terminal of the switch,
wherein the capacitor and the power management circuit coupled to the second terminal of the switch, and
wherein the first communications protocol connector is on a surface of the first device.

17. The system of claim 13, wherein the first device includes:
a third communications protocol connector;
a control circuit coupled to the first communications protocol connector and the third communications protocol connector;
a communications protocol receive pin coupled to the first communications protocol connector; and
a communications protocol transmit pin coupled to the third communications protocol connector.

18. The system of claim 13,
wherein the first device includes a ground pin; and
wherein the first device does not include a dedicated power supply pin.

19. A method comprising:
receiving a communication signal at a universal asynchronous receiver-transmitter (UART) receive (RXD) pin on a device;
charging a capacitor in the device when the communication signal has a first voltage level; and
discharging the capacitor when the communication signal has a second voltage level.

20. The method of claim 19, further comprising:
activating a switch in the device when the communication signal has the first voltage level, wherein the switch is coupled to the UART RXD pin and the capacitor; and
deactivating the switch when the communication signal has the second voltage level.
